(19) United States
(12) Patent Application Publication
(10) Pub. No.: US 2001/0011337 A1
(43) Pub. Date: Aug. 2, 2001

(54) PROGRAMMABLE MULTIPLE SEQUENTIAL SECTOR LOCKING FOR SEMICONDUTOR MEMORIES

(76) Inventor: MASSOUD SHAMSHIRIAN, FREMONT, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/153,375

(22) Filed: Sep. 15, 1998

(51) Int. Cl. G06F 12/14

(52) U.S. Cl. 711/163

(57) ABSTRACT

A semiconductor memory such as a flash memory having addressable sectors of stored data with access to the stored data being controlled by control logic includes a register coupled to the control logic and having bits corresponding to data sectors to be protected and a protection code indicating that access to the identified sectors is to be controlled. The protection code can be identified by a single bit in the register to prevent either access to identified sectors or to prevent alteration of data in identified sectors. A plurality of memory sectors can be identified for protection in a single write cycle of the memory thereby improving system performance and simplifying firmware requirements.

### BACKGROUND OF THE INVENTION

This invention relates generally to semiconductor memories where data is stored in accessible sectors, and more particularly the invention relates to programmably protecting multiple sectors from access and from modification of data.

Data is stored in accessible sectors in semiconductor memories such as RAMS, ROMS, and flash memory. Access to selected sectors can be controlled, and altering data in RAMS and flash memories can be selectively controlled. Heretofore, each sector has to be addressed and locked or unlocked separately, thus requiring multiple write cycles for controlling access to groups of sectors.

The present invention is directed to an expeditious method and apparatus for programmably locking and unlocking multiple sectors.

### SUMMARY OF THE INVENTION

In accordance with the invention, the control logic for controlling access to memory sectors in a semiconductor memory is provided with a register which can store a plurality of sector numbers along with a control bit for indicating access to the identified sectors is locked. The control logic responds to inputs from the register to block access to or modification of data stored in the sectors when the sectors are addressed.

The register can be readily programmed to identify the sectors to be locked or unlocked. In one embodiment of a flash memory, a user defined number of sequential sectors can be locked/unlocked in a single microprocessor write cycle. System performance is improved and firmware requirements are simplified with the invention.

The invention and objects and features thereof will be more readily apparent from the following detailed description and appended claims when taken with the drawings.

### BRIEF DESCRIPTION OF THE DRAWINGS

FIG. 1 is a functional block diagram of a semiconductor memory including a register for protecting sector access in accordance with the invention.

FIG. 2 is a schematic of a register in FIG. 1 which provides sector protection.

FIG. 3 is a flow diagram of a protection algorithm for loading the register of FIG. 2.

FIG. 4 is a timing diagram for implementing the algorithm of FIG. 3.

### DETAILED DESCRIPTION OF ILLUSTRATIVE EMBODIMENT

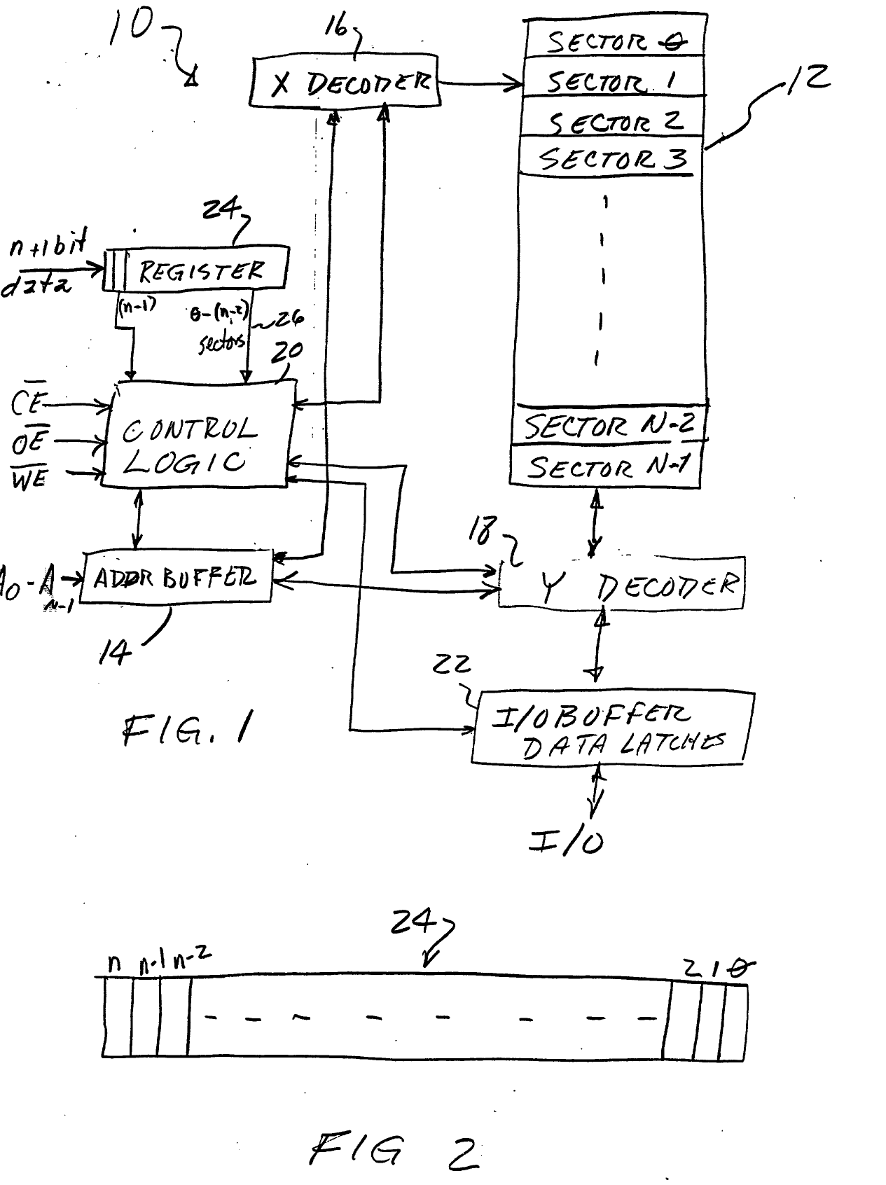

Referring now to the drawings, FIG. 1 is a functional block diagram of a semiconductor memory shown generally at 10 in which data are stored in a plurality of memory sectors 12. In one embodiment the memory consists of 512 equally sized sectors of 512 bytes each. The sectors 12 are accessed for reading data or altering data by addresses A₀ -Aₙ₋₁ received by an address buffer 14. The address buffer forwards memory addresses to an X decoder 16, a Y decoder 18, and control logic 20. Control logic 20 also receives chip enable bar,\overline{CE}, output enable bar, \overline{OE}, and write enable bar, \overline{WE}, as inputs and provides control signals to X decoder 16, Y decoder 18, and an input/output buffer and data latches 22.

In accordance with the invention a register 24 has N+1 bits with N−1 bits of register 16 corresponding to N sectors in memory array 12. One bit of register 24 (N−1) is a control bit for indicating whether identified sectors in register 24 are to be locked or unlocked. One bit of register (bit N) 24 is employed for parity check. FIG. 2 is a schematic of register 24 in accordance with one embodiment and shows the bits 0 through N-2 for identifying sectors 0 through N-2, with the N-1 bit being a 1 for locking of sectors and a 0 for unlocking of sectors. Bit N is the parity bit.

Referring again to FIG. 1, N+1 bits of data are loaded into register 24 for establishing protection of data sectors. Bits 0 through N-2 are connected at 26 to control logic 20 and the N-1 protection bit is applied to control logic 20.

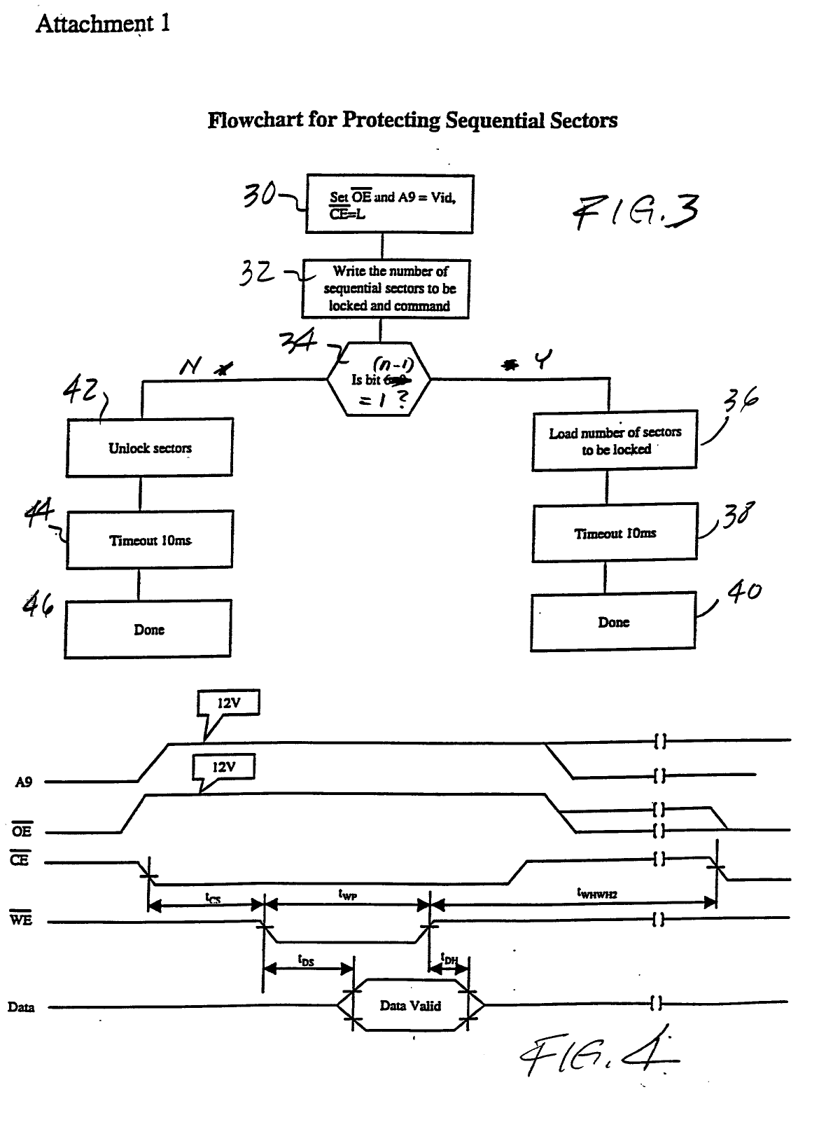

FIG. 3 is a flow chart of the algorithm for protecting sequential sectors using register 24 of FIGS. 1 and 2. Initially, at 30 the output enable bar, \overline{OE}, and a selected address bit, A9, are set to V_{id} (12 volts) for maximum input voltage.

Chip enable bar, \overline{CE}, is set low. The number of sequential sectors to be locked and the command (lock, unlock) are then written at 32. At 34 bit N-1 is checked for a value of 1, or for protection of the identified sectors. If yes, then the number of sectors to be locked are loaded in the register at 36 followed by a timeout period 38 whereupon the register is loaded with the sectors and the command at 40.

If at 34 bit N-1 is 0 then all sectors are unlocked at 42 followed by a timeout period 44 whereupon control logic 20 is free to allow access to all sectors at 46 for either the access of data or the altering of data.

FIG. 4 is a timing diagram for the operation of the algorithm of FIG. 3. Address A9 and \overline{OE} must first rise to V_{id} (12 volts) and chip enable bar, \overline{CE}, must be low. The algorithm of FIG. 3 is implemented during one write enable cycle (\overline{WE}=low) during which the data in the register becomes valid.

The invention improves system performance and simplifies firmware requirements in controlling access to multiple sectors in a single write cycle. While the invention has been described with reference to a specific embodiment, the description is illustrative of the invention and is not to be construed as limiting the invention. For example, locking mode can be entered by a fixed sequence of commands including address and data. Thus, various modifications and applications may occur to those skilled in the art without departing from the true spirit and scope of the invention as defined by the appended claims.

What is claimed is:

1. A protectable semiconductor memory comprising
a) a plurality of addressable sectors for storing data,
b) a plurality of decoders for addressing sectors in response to address signals,
c) control logic responsive to control signals and address signals for controlling the plurality of decoders, and
d) a register coupled to the control logic for storing sector identification and a protection code, the control logic being responsive to the sector identification and protection code to control access to identified sectors.

2. The memory as defined by claim 1 wherein said register has one bit corresponding to each sector and at least one bit for indicating a protection mode.

3. The memory as defined by claim 2 wherein the protection code prevents altering stored data.

4. The memory as defined by claim 2 wherein the protection code prevents access to stored data.

5. The memory as defined by claim 2 wherein the control signals include chip enable, output enable and write enable.

6. The memory as defined by claim 5 wherein the semiconductor memory comprises a flash memory.

7. The memory as defined by claim 1 wherein the semiconductor memory comprises a flash memory.

8. In a semiconductor memory having addressable sectors of stored data with access to the stored data being controlled by control logic, apparatus for limiting user access to the stored data comprising a register coupled to the control logic and including bits corresponding to data sectors to be protected and at least one bit for storing a protection code indicating access to identified sectors is to be controlled.

9. Apparatus as defined by claim 8 wherein the protection code is identified by one bit in the register.

10. Apparatus as defined by claim 9 wherein the protection code limits access to data sectors.

11. Apparatus as defined by claim 9 wherein the protection code prevents alteration of stored data.

12. Apparatus as defined by claim 9 wherein parity is one bit in the register.

13. A method of protecting access to data stored in addressable sectors in a semiconductor memory, said memory having control logic to control sector access, said method comprising the steps of:
a) providing a programmable register for identifying sectors for protection and a protection code for identifying the level of protection, and
b) coupling the register to the control logic whereby the control logic responds to the protection code in controlling access to identified sectors.

14. The method as defined by claim 13 wherein the protection code limits alteration of stored data.

15. The method as defined by claim 13 wherein the protection code limits access to stored data.

16. The method as defined by claim 13 wherein said register can be programmed in one write cycle.
